(19) United States
(12) Patent Application Publication
(10) Pub. No.: US 2012/0000796 A1
(43) Pub. Date: Jan. 5, 2012

(54) Measurement Device and Method Utilizing the Same

(75) Inventors: Jung-Chuan Chou, Douliou City (TW); Wei-Lun Hsia, Caotun Township (TW); Chien-Cheng Chen, Taichung City (TW)

(73) Assignee: National Yunlin University of Science and Technology, Douliou City (TW)

(21) Appl. No.: 13/162,037

(22) Filed: Jun. 16, 2011

(30) Foreign Application Priority Data
Jul. 5, 2010 (TW) 99121968

(51) Int. Cl. G01N 27/26

(52) U.S. Cl. 205/793.5; 204/435; 204/406

(57) ABSTRACT

A measurement device measuring a solution and including a reference voltage generating unit, a plurality of sensing units, a reading unit and a processing unit is disclosed. The reference voltage generating unit is disposed in the solution to generate a reference voltage. The sensing units are disposed in the solution to generate a plurality of output signals relating to the reference voltage. The reading unit outputs a reading signal according to one of the output signals. The processing unit generates a measuring signal according to the reading signals.

### CROSS REFERENCE TO RELATED APPLICATIONS

This Application claims priority to Taiwan Patent Application No. 099121968, filed on Jul. 5, 2010, the entirety of which is incorporated by reference herein.

### BACKGROUND OF THE INVENTION

1. Field of the Invention

The invention relates to a measurement device, and more particularly to a measurement device to measure a solution.

2. Description of the Related Art

The direct measurement of hydrogen ion activity of an aqueous solution by glass membrane sensors was a valuable technique used to monitor and analyze chemistry component for many years. However, due to a need for wet storage, and the fragility, large size and high cost of the glass membrane sensors, after 1970, solid-state sensors were used as a substitute for glass membrane sensors.

In 1970, Bergveld (ref.[1] P. Bergveld, entitled “Development of an ion-sensitive solid state device for neurophysiological measurements”, IEEE Transactions on Bio-medical Engineering, vol. BME-17, pp. 70-71, 1970.) utilizes MOSFET technology to fabricate a first ion-sensitive field-effect transistor (ISFET). The ISFET was able to meet requirements for miniaturization, fast response and high input impedance.

In 1984, Fog and Buck (ref.[2] A. Fog, R. P. Buck, entitled “Electronic semi-conducting oxides as pH sensors”, Sensors and Actuators, vol. 5, pp. 137-146, 1984.) utilizes a metal oxide to fabricate a hydrogen ion sensor. The structure of the hydrogen ion sensor was different from the structure of the conventional glass sensor. Fog and Buck utilized various metal oxides to fabricate working electrodes. The working electrodes were able to meet requirements for fast response times, portability and easy store. Thus, working electrodes did not have the problems of the conventional glass sensor.

In recent years, with the improvement of living standards, a variety of ion sensors are now widely being used in various fields, such as the clinical trial, automation industry, and environmental monitoring fields. It is important for the ion sensor, to increase the accuracy and stability of sensors, to reduce the costs of sensors and to eliminate the unstable phenomenon of sensors caused by non-ideal effects.

Common non-ideal effects comprise a time drift effect and a delay effect. In a fixed environment, the output level of a measurement sensor drifts following a long measurement time period. Thus, the measurement sensor is unstable and provides an error sensing result due to drifting output levels. The time drift effect limits the applicable fields of the measurement sensor. When a multitude of solvents are repeatedly measured in a fixed environment, the measurement results for the same solvent are different. Bousse et al. (ref.[3] L. Bousse, S. Mostarshed, B. Schoot, and N. Rooji, entitled “ Comparison of the hysteresis of Ta₂O₅ and Si₃N₄ pH-sensing insulators”, Sensors and Actuators B, vol. 17, pp. 157-164, 1994.) determined that a sensing membrane has a memory effect, which is important.

In United States Patent, U.S. Pat. No. 4,701,253 (Hendrikus C. G. Ligtenberg, Jozef G. M. Leuveld, Date of Patent: Oct. 20, 1987, entitled “ISFET-Based measuring device and method for correcting drift”) disclosed a device and a method, which utilizes an ISFET structure to correct drift. The device comprises an ISFET, a reference electrode, an amplifier, a control/correction circuit, a memory, a sample/hold circuit and a micro-processor. The control/correction circuit stabilizes the source current of the ISFET to correct the time drift caused in the ISFET. The micro-processor corrects the time drift caused in the ISFET according to a logarithmic equation: ΔVₚ=A·ln(t/t₀+1), where: ←Vₚ is potential drift, A means scale factor for drift and amplitude, tₒ is time constant defining the dependence on time, and t indicates the time during which the sensor is operative in the event of continuous operation. However, the device is complex.

In the United States Patent, U.S. Pat. No. 4,691,167 (Hendrik H. v. d. Vlekkert, Nicolass F. de Rooy, Date: Sep. 1, 1987, entitled “Apparatus for determining the activity of an ion (pIon) in a liquid”) disclosed a device for detecting the activity of an ion. The device comprises a measuring circuit including an ISFET, a reference electrode, a temperature sensor, an amplifier, a control-calculating circuit and a memory. The control-calculating circuit and the memory provide parameters to stabilize the ISFET. The parameters comprise a gate-source across voltage and a source current to detect the activity of an ion. The changes of the gate voltage and the source current are controlled by controlling temperature, and the data stored in the memory is calculated to obtain the sensitivity of the device.

In the United States Patent, U.S. Pat. No. 5,046,028 (Avron I. Bryan, Michael R. Cushman, Date of Patent: Sep. 3, 1991, entitled “System for calibrating, monitoring and reporting the status of a pH sensor”) disclosed a system to execute a measurement work on-line and in real-time. The sensor periodically detects a characteristic between a membrane and a solvent. The sensor is disposed in a fixed container. The fixed container does not relate to the flow velocity of the solvent. The sensor is covered by a non-conductive material and comprises a backflow device such that the solvent stably passes through the surface of the membrane. The system comprises a measurement circuit, an analog-digital converter, a computer system and a display device.

In United States Patent, U.S. Pat. No. 6,624,637 (Torsten Poechstein, Date of Patent: Sep. 23, 2003, entitled “Device for measuring the concentrations in a measuring liquid”) provided an element to measure the concentration of ions. For measuring the concentration of hydrogen ions, the ISFET is integrated into an electric circuit. The concentration of hydrogen ions is measured according to the output signal of the electric circuit. To simplify the electric circuit, the electric circuit is constituted by various elements. The elements comprise at least one ISFET, bridged to three resistors. Ion response levels are obtained according to the across voltage of the ISFET.

In Taiwan Patent, TW Pat. No.: I 279,538 (Shen-Kan Hsung, Jung-Chuan Chou, Tai-Ping Sun, Chung-We Pan and Chu-Neng Tsai, Date of Patent: Apr. 21, 2007, entitled “Drift calibration method and device for the potentiometric sensor”) provided a method and a device to correct the drift effect being caused in a sensor. The method shifts the sensing signal to utilize differential technology such that signal drifting during a long measuring time period is eliminated. The device comprises two voltage sensors, a readout circuit, a signal shift circuit and a differential circuit to output a response signal without time drift.

A paper by Morgenshtin in SCI periodical discloses a new readout circuit for an ISFET. The new readout circuit utilizes a Wheatstone bridge and operation principles of the ISFET/REFET. The readout circuit comprises a correction circuit comprising four FETs. When an output signal drifts, the Wheatstone bridge increases the energy of the output signal to resist interference and noise. (ref.[4] Morgenshtin, L. Boreysha, and U. Dinner, in titled of “ Wheatstone-bridge readout interface for ISFET/REFET applications”, Sensors and Actuators B, vol. 98, pp. 18-27, 2004.).

A paper by Jamasb in SCI periodical discloses a method to correct the time drift caused in an ISFET. The method utilizes a transient drifting rate of the ISFET to correct and compensate for the drifted signal generated by a sensor. Jamasb et al. utilizes an Si₃N₄ gate acid-base (pH) sensing method to execute an ISFET demonstration. The method is effective for successive detections (ref.[5] S. Jamasb, entitled “ An analytical technique for counteracting drift in ion-selective field effect transistor (ISFETs)”, IEEE Sensors Journal, vol. 4, pp. 795-801, 2004.).

### BRIEF SUMMARY OF THE INVENTION

In accordance with an embodiment, a measurement device, which measures a solution, comprises a reference voltage generating unit, a plurality of sensing units, a reading unit and a processing unit. The reference voltage generating unit is disposed in the solution to generate a reference voltage. The sensing units are disposed in the solution to generate a plurality of output signals relating to the reference voltage. The reading unit outputs a reading signal according to one of the output signals. The processing unit generates a measuring signal according to the reading signals.

A measurement method to measure a solution is provided. An exemplary embodiment of the measurement method is described in the following. A reference voltage is generated in the solution. A plurality of output signals are obtained in the solution. The output signals relate to the reference voltage. A reading signal is generated according to the output signals. The reading signal is processed to generate a measuring signal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a measurement device of the invention;

FIG. 2 is a schematic diagram of an exemplary embodiment of a measurement method of the invention;

FIGS. 3, 5 and 7 show measuring results of a conventional measurement device;

FIGS. 4, 6 and 8 show measuring results of the measurement device of the invention; and

FIG. 9 is a comparing table of the conventional measurement device and the measurement device of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

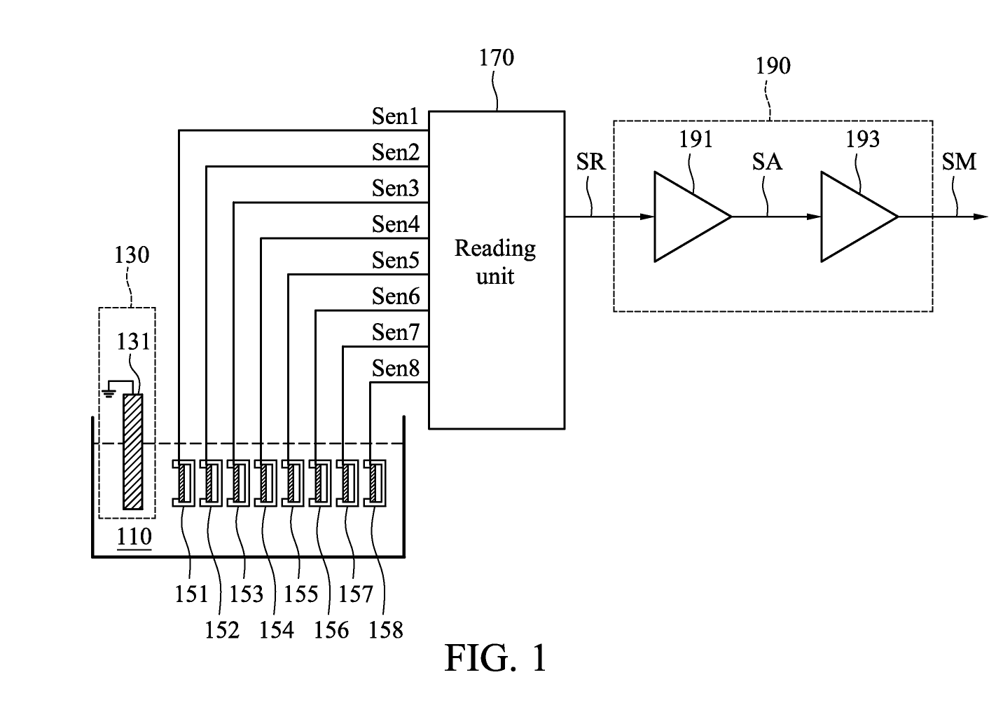

FIG. 1 is a schematic diagram of an exemplary embodiment of a measurement device of the invention. The measurement device measures a solution 110. The invention does not limit the type of the solution 110. In this embodiment, the solution 110 is a buffer solution and the pH value of the solution 110 is within pH1˜pH13. As shown in FIG. 1, the measurement device comprises a reference voltage generating unit 130, sensing units 151˜158, a reading unit 170 and a processing unit 190.

The reference voltage generating unit 130 is disposed in the solution 110 to generate a reference voltage. In this embodiment, the reference voltage generating unit 130 generates a fixed voltage. Thus, in one embodiment, the reference voltage generating unit 130 is an electrode 131. The invention does not limit the kind of the electrode 131. In one embodiment, the electrode 131 is an Ag/AgCl electrode.

The sensing units 151˜158 are disposed in the solution 110 to generate output signals Sen1˜Sen8. The output signals Sen1˜Sen8 relate to the reference voltage. In one embodiment, each of the sensing units 151˜158 generates a sensing signal according to the pH value of the solution 110. Each of the sensing units 151˜158 then generates an output signal according to a voltage difference between a corresponding sensing signal and the reference voltage. The reference voltage is generated by the reference voltage generating unit 130.

Furthermore, in this embodiment, the measurement device comprises eight sensing units 151˜158, but the disclosure is not limited thereto. In other embodiments, the measurement device comprises at least two sensing units.

Additionally, the output signals Sen1˜Sen8 are voltage signals in this embodiment. In other words, the sensing units 151˜158 are voltage sensing units. In other embodiment, the output signals Sen1˜Sen8 relate to the pH value of the solution 110.

The reading unit 170 outputs a reading signal SR according to the output signals Sen1˜Sen8. In one embodiment, the reading unit 170 is an instrumentation amplifier or a voltage amplifier. The reading unit 170 amplifies the output signals Sen1˜Sen8 and outputs the amplified output signals. Each of the amplified output signals Sen1˜Sen8 can be served as the reading signal SR. In one embodiment, the reading unit 170 can successively or unsuccessively read and amplify the output signals Sen1˜Sen8. Additionally, the reading unit 170 can successively or unsuccessively output the amplified results.

The processing unit 190 generates a measuring signal SM according to the reading signal SR. In this embodiment, the processing unit 190 comprises an addition circuit 191 and a division circuit 193. The addition circuit 191 adds all reading signals SR up to generate a total signal SA. The invention does not limit the kind of the addition circuit 191. In one embodiment, the addition circuit 191 is a non-inverting adder or an inverting adder.

Since the reading unit 170 reads eight output signals, the reading unit 170 can generate eight reading signals. The addition circuit 191 adds the eight reading signals up. In one embodiment, a multiple relation exists between the total signal SA and the output signals Sen1˜Sen8. For example, SA=Sen1+Sen2+ . . . +Sen8. In one embodiment, SA=XSen1+XSen2+ . . . +XSen8 if the reading unit 170 is an amplifier, wherein X is an amplifying factor of the reading unit 170.

The division circuit 193 generates the measuring signal SM by dividing the total signal SA by a pre-determined value. The pre-determined value relates to the number of the sensing units. In this embodiment, the pre-determined value is equal to the number of the sensing units. Thus, if the amplifying factor of the reading unit 170 equals to 1, the measuring signal SM is an average value of the output signals Sen1˜Sen8. In other words, SM=(Sen1+Sen2+ . . . +Sen8)/8. The invention does not limit the kind of the division circuit 193. In some embodiments, the division circuit 193 is a non-inverting divider, an inverting divider or a voltage divider.

The measuring signal SM processed by the processing unit 190 has great stability and sensitivity. The processing unit 190 reduces drift rate and delay effect of the measuring signal SM. The time drift rate and the delay effect of the invention is batter than the conventional technology, as discussed in more detail below.

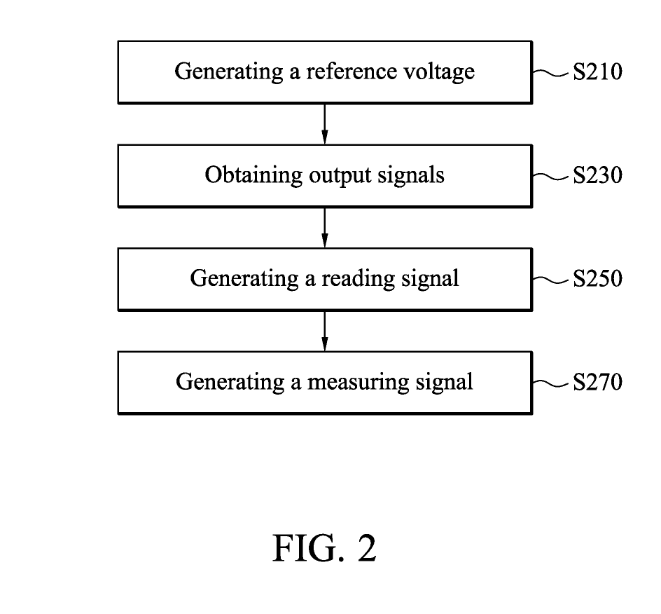

FIG. 2 is a schematic diagram of an exemplary embodiment of a measurement method of the invention. The measurement method is utilized to measure a solution. First, a reference voltage is generated in a solution (step S210). In one embodiment, an electrode is disposed in the solution to generate a fixed reference voltage. The invention does not limit the kind of the electrode. In one embodiment, the electrode is an Ag/AgCl electrode.

Next, the solution is measured to obtain a plurality of output signals (step S230). In this embodiment, the output signals relate to the reference voltage. For example, a multitude of sensing signals is obtained after measuring the solution. Output signals can be generated according to voltage differences between the reference voltage and the sensing signals.

The invention does not limit the method for sensing the solution. In one embodiment, a plurality of sensing units is disposed in the solution to obtain a plurality of output signals. Additionally, the invention does not limit the kind of the sensing unit and the number of the sensing units. In one embodiment, the sensing unit is a voltage pH sensor, which generates a corresponding voltage signal according to the pH value of the solution.

A reading signal is generated according to the output signals (step S250). In one embodiment, a reading circuit is utilized to read the output signals. The invention does not limit the kind of the reading circuit. In one embodiment, the reading circuit is an instrumentation amplifier or a voltage amplifier.

For example, the reading circuit receives one of the output signals and then amplifies the received output signal. The amplified output signal is served as the reading signal. Then, the reading circuit receives another output signal and amplifies the output signal to serve another reading signal until all output signals are amplified.

The reading signals are processed to generate a measuring signal (step S270). The invention does not limit the processing method for the reading signals. In one embodiment, the reading signals are processed by an addition circuit and a division circuit. In this case, the addition circuit adds the reading signals, and the division circuit divides the added result by a pre-determined value. Thus, a measuring signal is generated according to the processing results of the addition circuit and the division circuit. In one embodiment, the pre-determined value relates to the number of the output signals.

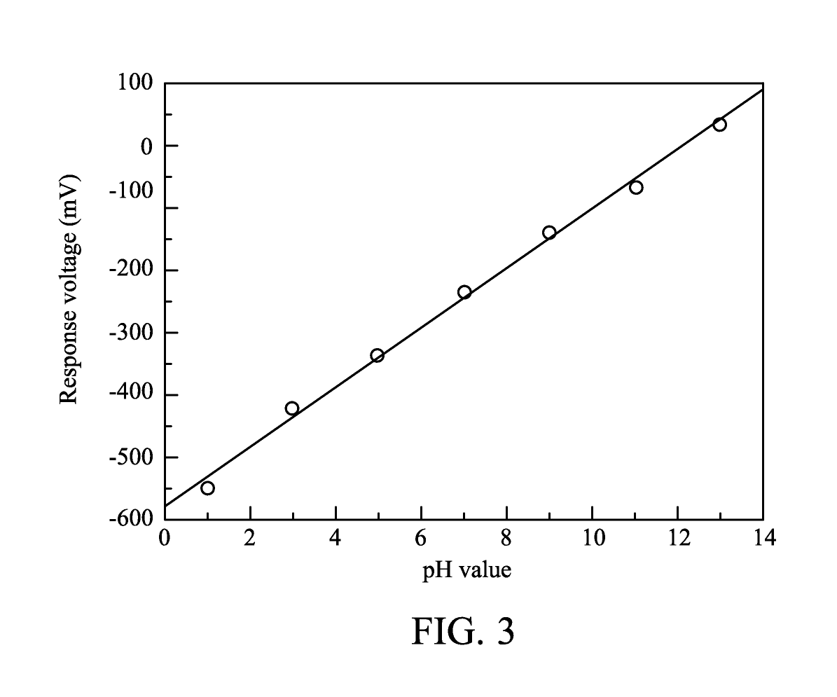

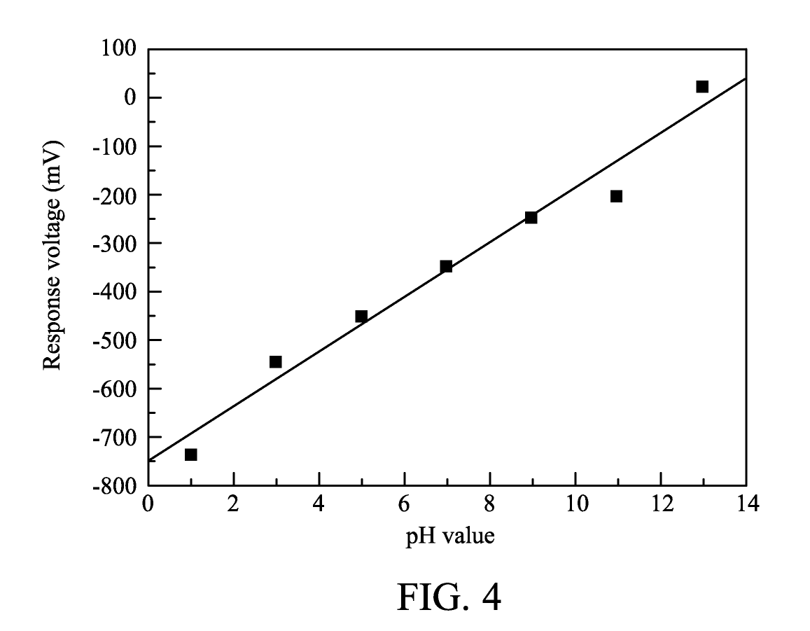

FIG. 3 shows a measuring result generated by a conventional measurement device. FIG. 4 shows a measuring result generated by the measurement device of the invention. Assume that the conventional measurement device only comprises one sensing unit and the measurement device of the invention comprises eight sensing units, but the disclosure is not limited thereto.

The conventional measurement device and the measurement device of the invention measure buffer solutions. The pH values of the buffer solutions are pH1, pH3, pH5, pH7, pH9, pH11 and pH13. FIGS. 3 and 4 show the measured results. Refer to FIG. 3, the sensitivity of the convention measurement device is about 47.107 mV/pH. Refer to FIG. 3, the sensitivity of the measurement device of the invention is about 56.008 mV/pH. The measurement device of the invention increases sensitivity. The increased sensitivity is about 18.90%.

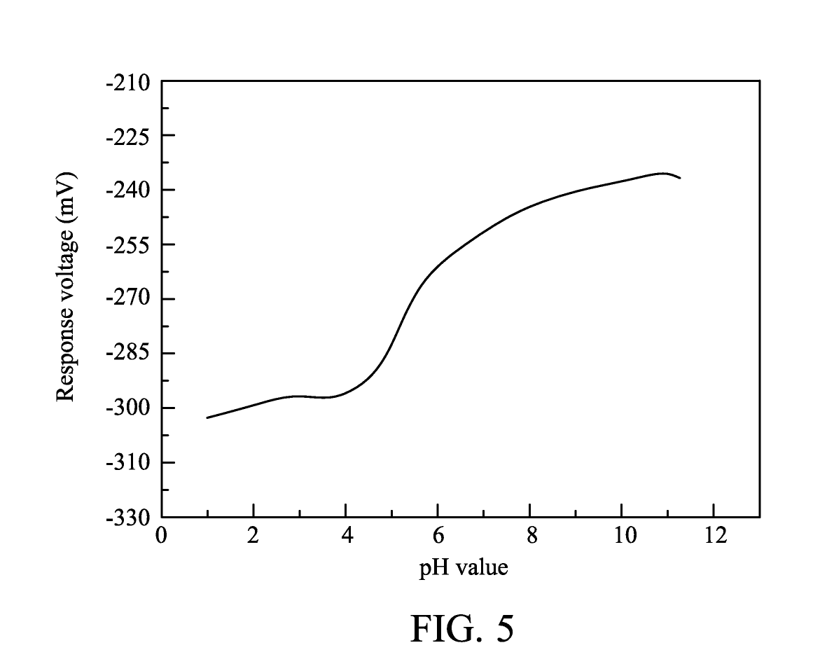

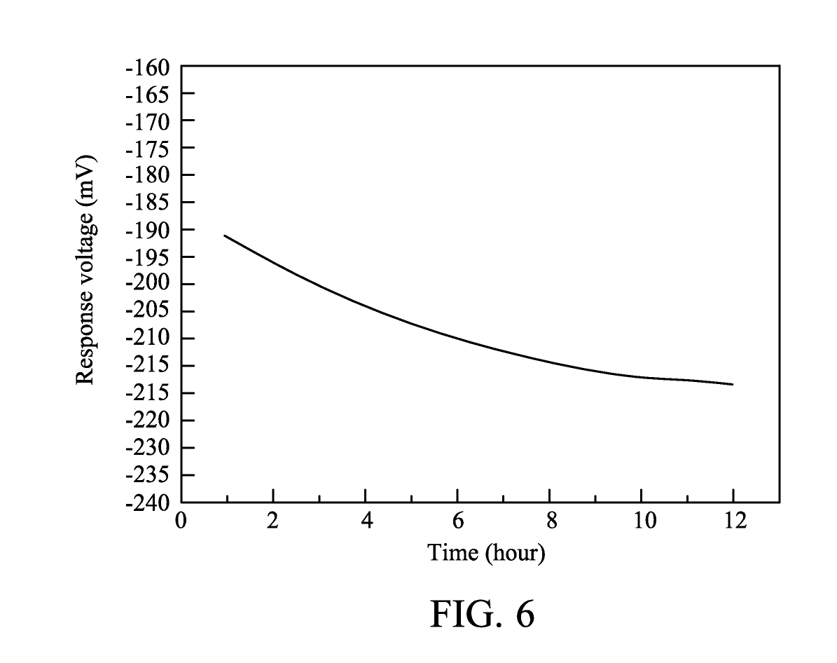

FIG. 5 shows a measuring result of a conventional measurement device. FIG. 6 shows a measuring result of the measurement device of the invention. Similarly, assume that the conventional measurement device only comprises one sensing unit and the measurement device of the invention comprises eight sensing units, but the disclosure is not limited thereto.

The time drift curve shown in FIG. 5 is obtained when the conventional measurement device measures a buffer solution for 12 hours and the pH value of the measured buffer solution is pH7. Similarly, the time drift curve shown in FIG. 6 is obtained when the measurement device of the invention measures a buffer solution for 12 hours and the pH value of the measured buffer solution is pH7.

Refer to FIG. 5, the time drift rate of the conventional measurement device is about 6.366 mV/hour. Refer to FIG. 6, the time drift rate of the measurement device of the invention is about 1.638 mV/hour. After comparing FIGS. 5 and 6, it is obtained that the measurement device of the invention reduces the time drift rate and the reduced range is about 74.27%.

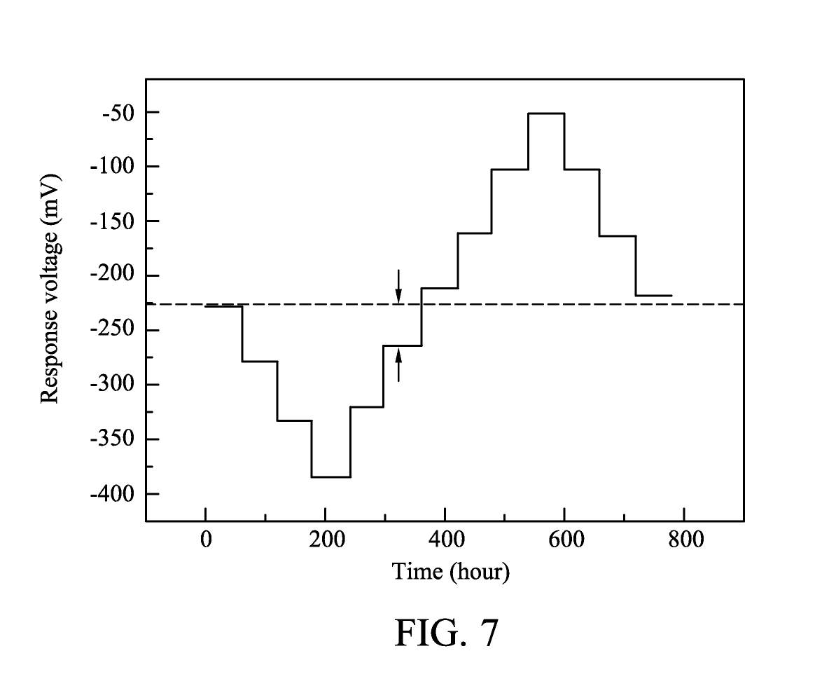

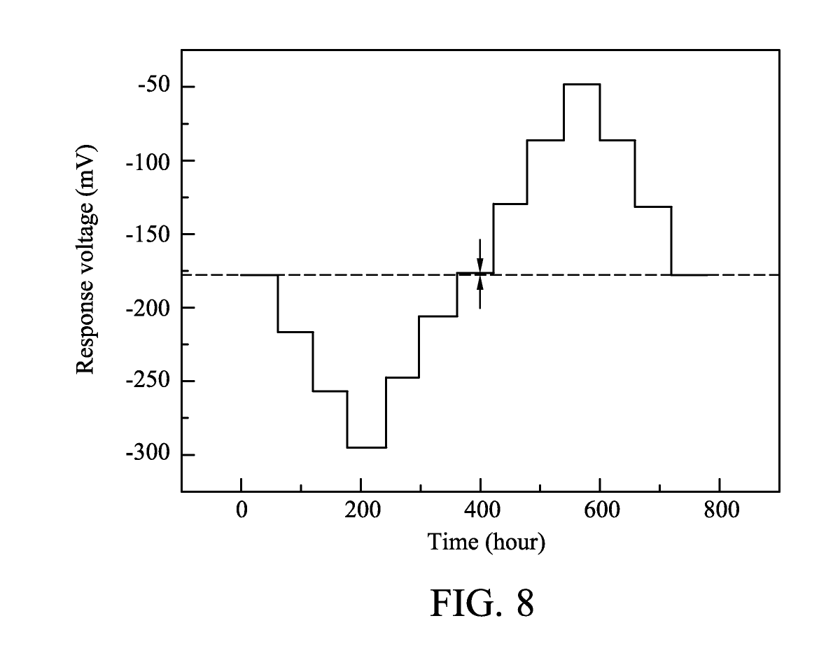

FIG. 7 shows a measuring result of a conventional measurement device. FIG. 8 shows a measuring result of the measurement device of the invention. Assume that the convention measurement device only comprises one sensing unit and the measurement device of the invention comprises eight sensing units, but the disclosure is not limited thereto.

The conventional measurement device successively measures a plurality of solutions and the pH values of the solutions are pH4·pH10. The measuring sequence is pH7→pH6→pH5→pH4→pH5→pH6→pH7→pH8→pH9→pH10→pH9→pH8→pH7. After measuring, the measured result of the conventional measurement device is shown in FIG. 7. If the measurement device of the invention measures the above solutions, the delay curve shown in FIG. 8 can be obtained.

Refer to FIG. 7, the maximum delay width of the conventional measurement device is 14.938 mV. Refer to FIG. 8, the maximum delay width of the measurement device of the invention is 1.118 mV. After comparing FIGS. 7 and 8, it is obtained that the measurement device of the invention reduces the delay amount by about 92.52%.

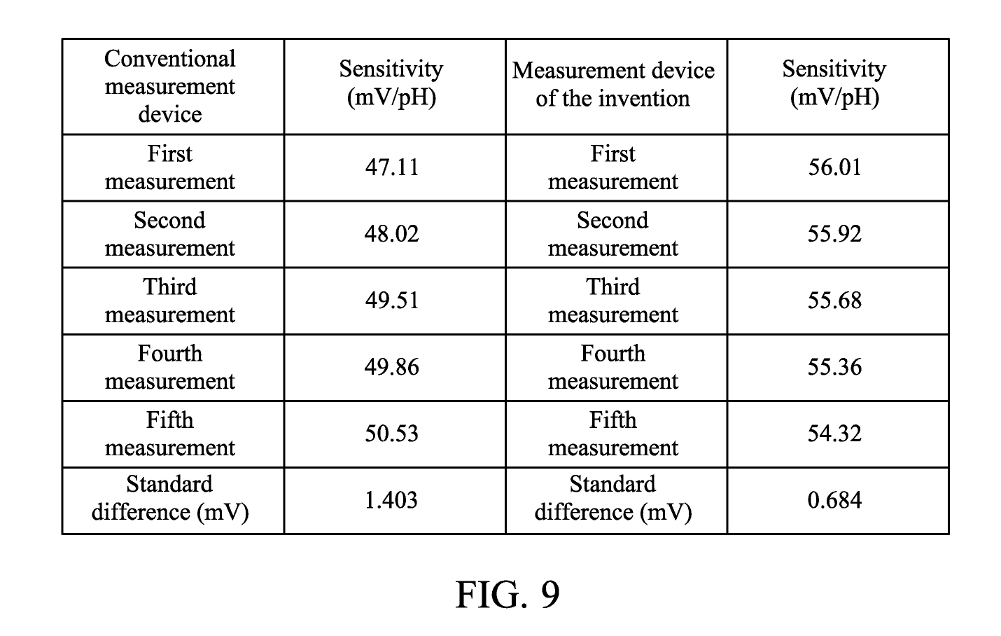

FIG. 9 is a comparing result after comparing the measuring results of the conventional measurement device and the measurement device of the invention. FIG. 9 can be obtained when the conventional measurement device and the measurement device of the invention measure the solutions five times and the pH values are pH1, pH3, pH5, pH7, pH9, pH11 and pH13. Refer FIG. 9, the standard difference in the conventional measurement device is 1.403 mV and that in the measurement device of the invention is 0.684 mV.

According to the comparing result, the measurement device of the invention provides better sensitivity and stability. Further, the measurement device of the invention reduces the time drift effect and the delay effect for long measurement time periods.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A measurement device measuring a solution, comprising:
a reference voltage generating unit disposed in the solution to generate a reference voltage;
a plurality of sensing units disposed in the solution to generate a plurality of output signals relating to the reference voltage;
a reading unit outputting a reading signal according to one of the output signals; and
a processing unit generating a measuring signal according to the reading signals.

2. The measurement device as claimed in claim 1, wherein the reference voltage generating unit is an electrode.

3. The measurement device as claimed in claim 2, wherein the electrode is an Ag/AgCl electrode.

4. The measurement device as claimed in claim 1, wherein the output signals are voltage signals.

5. The measurement device as claimed in claim 1, wherein the output signals relate to the pH value of the solution.

6. The measurement device as claimed in claim 1, wherein the reading unit is an instrumentation amplifier or a voltage amplifier.

7. The measurement device as claimed in claim 1, wherein the processing unit comprises:
an addition circuit adding the read signals and outputting a total signal; and
a division circuit dividing the total signal by a pre-determined value to generate the measuring signal.

8. The measurement device as claimed in claim 7, wherein the addition circuit is a non-inverting adder or an inverting adder.

9. The measurement device as claimed in claim 7, wherein the pre-determined value relates to the number of the sensing units.

10. The measurement device as claimed in claim 9, wherein the measuring signal is an average value of the output signals.

11. The measurement device as claimed in claim 7, wherein the division circuit is a non-inverting divider, an inverting divider or a voltage divider.

12. A measurement method to measure a solution, comprising:
generating a reference voltage in the solution;
obtaining a plurality of output signals in the solution, wherein the output signals relate to the reference voltage;
generating a reading signal according to the output signals; and
processing the reading signal to generate a measuring signal.

13. The measurement method as claimed in claim 12, wherein an electrode is disposed in the solution to generate the reference voltage.

14. The measurement method as claimed in claim 12, wherein an addition circuit and a division circuit are utilized to process the reading signal.
